(19) United States
(12) Patent Application Publication
(10) Pub. No.: US 2025/0140138 A1
(43) Pub. Date: May 1, 2025

(54) VEHICLE MOUNTED CRASH ATTENUATOR

(71) Applicant: TRAFFIX DEVICES, INC., San Clemente, CA (US)

(72) Inventors: Geoffrey B. Maus, Trabuco Canyon, CA (US); Connor Dagg, San Clemente, CA (US)

(21) Appl. No.: 18/917,362

(22) Filed: Oct. 16, 2024

Related U.S. Application Data
(60) Provisional application No. 63/546,489, filed on Oct. 30, 2023.

(51) Int. Cl. G09F 21/04; E01F 15/14; G08G 1/09; G09F 7/18

(52) U.S. Cl. CPC G09F 21/04; G08G 1/09; G09F 7/18; E01F 15/148; G09F 2007/1843

(57) ABSTRACT

A crash impact attenuator for deployment on a construction vehicle includes an energy-absorbing portion, having a backup frame adapted to join the crash impact attenuator to a vehicle, and a sign holder frame extending upwardly from the backup frame. The sign holder frame is adapted to support a first informational sign. Two upwardly extending support posts extend from one of the backup frame and an energy-absorbing portion frame, for supporting a second informational sign forwardly of the sign holder frame, so that the second informational sign is behind the sign holder frame from an approaching motorist's point of view. The support posts may be raised to a display position, with the second informational sign thus being positioned above the sign holder frame, and may further be lowered to a stowed position, so that the second informational sign is positioned behind the sign holder frame.

This application claims the benefit under 35 U.S.C. 119(e) of the filing date of U.S. Provisional Patent Application Ser. No. 63/546,489 entitled Vehicle-Mounted Crash Attemiator, and filed on Oct. 30, 2023, the entire contents of which are herein expressly incorporated by reference.

### BACKGROUND OF THE INVENTION

Truck mounted attenuators (TMA's) have been in use for many years. TMA's typically comprise a fixed backup mounted to a dump truck or other vehicle and an energy absorbing cartridge attached to the fixed backup. In some TMA's, the cartridge is attached to the fixed backup via a hinge to allow for rotation of the cartridge to a vertical orientation for transport. The TMA cartridge absorbs the impact of an errant vehicle that collides with it, thereby protecting the truck, the vehicle, and the occupants of both. The applicant and assignee for the present application sells a very popular TMA under the trademark SCORPION, and variants, versions of which are shown and described in U.S. Pat. Nos. 6,581,992,6,926,324, 7,243,964, 7,438,337, 11,400,884, 11,247,624, and 11,648,897, all of which are herein expressly incorporated by reference, in their entirety.

One important purpose for the TMA's deployed on trucks and other vehicles, typically those used in highway construction, is for protecting workers in those vehicles. The trucks equipped with TMA's are referred to as shadow vehicles, barrier vehicles, and advance warning vehicles. Shadow vehicles are moving trucks that effectively block errant vehicles in the flow of traffic from striking the workers directly ahead of the truck. The protected workers typically perform mobile activities, such as crack pouring, patching utility work, striping, coning, pavement repair, pavement marking, and delineator repair, and the shadow vehicle moves with and behind the workers. Barrier vehicles are effectively used to protect vehicles in the flow of traffic from a hazardous situation, such as blocking open excavations. The barrier vehicles may be unoccupied.

Advance warning vehicles may be used to warn the drivers in the flow of traffic of an upcoming moving or stationary situation. An example of an advance warning vehicle is a truck in a lane of a highway displaying an arrow indicating that the lane is closed ahead and that vehicles in the lane need to start to merge into another lane.

It is known in the prior art to display signs on a frame mounted on the vehicle on which the TMA is mounted, which vehicle may be, as noted above, identified as an “advance warning vehicle”. This frame may extend upwardly from a backup frame utilized to attach the TMA to the vehicle, via a hitch system, such as the hitch system disclosed in the assignee's U.S. Pat. No. 8,870,251, also herein expressly incorporated by reference. The hitch system disclosed in U.S. Pat. No. 8,870,251 is sold by the assignee under the trademark FAST-TRAK SWIFCONNECT.

What is needed is a system which comprises an informational sign and a separate arrowboard so that both the informational sign and accompanying arrow board are visible to approaching motorists, but are also compactly stowable when not in use.

### SUMMARY OF THE INVENTION

The present invention comprises, in one particular aspect, a crash impact attenuator for deployment on a vehicle such as a truck, which comprises an energy-absorbing portion, including a frame for supporting the energy-absorbing portion, a backup frame adapted to join the crash impact attenuator to a vehicle, and a sign holder frame extending upwardly from the backup frame, or, alternatively, from the support frame for supporting the energy-absorbing portion. The sign holder frame is adapted to support a first informational sign. The inventive combination further comprises at least one upwardly extending support post extending from one of the backup frame and the energy-absorbing portion frame, for supporting a second informational sign forwardly of the sign holder frame, so that the second informational sign is behind the sign holder frame from an approaching motorist's point of view.

The at least one upwardly extending support post may be raised to a display position, with the second informational sign thus being positioned above the sign holder frame, and may further be lowered to a stowed position, so that the second informational sign is positioned behind the sign holder frame.

The first informational sign, in one example, may display information related to a traffic condition, and the second information sign may comprise an arrowboard.

The at least one upwardly extending support post may, in illustrated embodiments, comprise two upwardly extending support posts, and may be of a telescoping construction. A hydraulic powered vertical lift is arranged to raise and lower the at least one upwardly extending support post. In some instances, the crash impact attenuator comprises an on-board hydraulic system for rotating the crash impact attenuator into both travel/storage and deployed orientations, and the hydraulic powered vertical lift is powered by the on-board hydraulic system.

In illustrated embodiments, the at least one upwardly extending support post extends from the backup frame.

In another aspect of the invention, there is described a method of displaying informational messages to passing motorists from a construction vehicle equipped with a rear-mounted crash attenuator, wherein the method comprises a step of providing a first informational sign disposed in a sign holder frame extending upwardly forwardly of the crash attenuator, and a step of providing a second informational sign disposed on at least one upwardly extending support post, wherein the second informational sign is displayed above the first informational sign. The inventive method further comprises a step of raising the at least one support post to dispose the second informational sign in a display position above the first informational sign, as well as a step of lowering the at least one support post to dispose the second informational sign in a stowed position behind the first informational sign.

### BRIEF DESCRIPTION OF THE DRAWINGS

FIG. 1 is a view from the rear of a deployed truck mounted attenuator attachable to a vehicle wherein an information sign and a mocked-up arrowboard are both displayed in accordance with the present invention;

FIG. 2 is a forward-facing view, from the side, showing a frame for displaying an information sign like that shown in FIG. 1 and a mocked-up arrowboard like that shown in FIG. 1, in a lowered, stowed position;

FIG. 3 is a side view showing the mocked-up arrowboard and information sign shown in FIGS. 1 and 2, with the arrowboard in a raised, deployed position, as also shown in FIG. 1;

FIG. 4 is a side view similar to FIG. 3, wherein the mocked-up arrowboard is in its lowered, stowed position, as shown in FIG. 2; and

FIG. 5 is a side view wherein the TMA is in a raised, stowed position and the arrowboard is in its lowered, stowed position, so that the combination is “packaged” for transport and storage.

### DETAILED DESCRIPTION OF THE INVENTION

Referring now to the drawing figures, wherein like reference numerals refer to like elements throughout the figures, a truck mounted crash attenuator (TMA) 10 is mountable to a rear end of a vehicle, such as a truck (not shown). In the illustrated embodiment, the TMA 10 is comprised of one or more energy absorbing members supported on a frame, which in the illustrated embodiment comprise a strut 12 and a cartridge 14, as described in any of the assignee's prior U.S. Pat. Nos. 6,581,992, 6,926,324, 7,243,964, 7,438,337, 11,400,884, 11,247,624, and 11,648,897, all of which are already expressly incorporated herein by reference. It should be noted, however, that the present invention is usable with any TMA, and is not limited to use with the assignee's TMA systems. The TMA strut 12 is attached to a backup frame 16 that is rigidly attachable to the vehicle rear end, in a manner that is known. One such attachment system, not required for this invention, but cited as an example, is the hitch system disclosed in U.S. Pat. No. 8,870,251, also already expressly incorporated herein by reference.

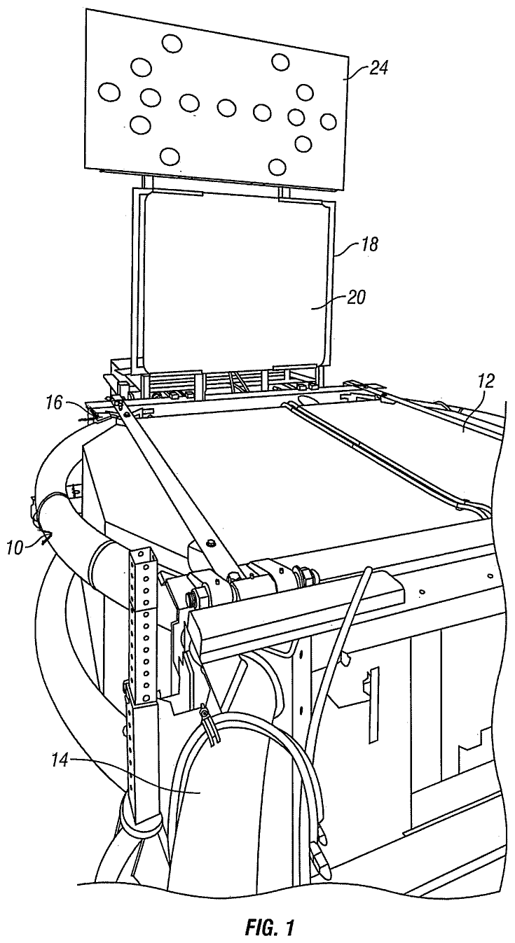

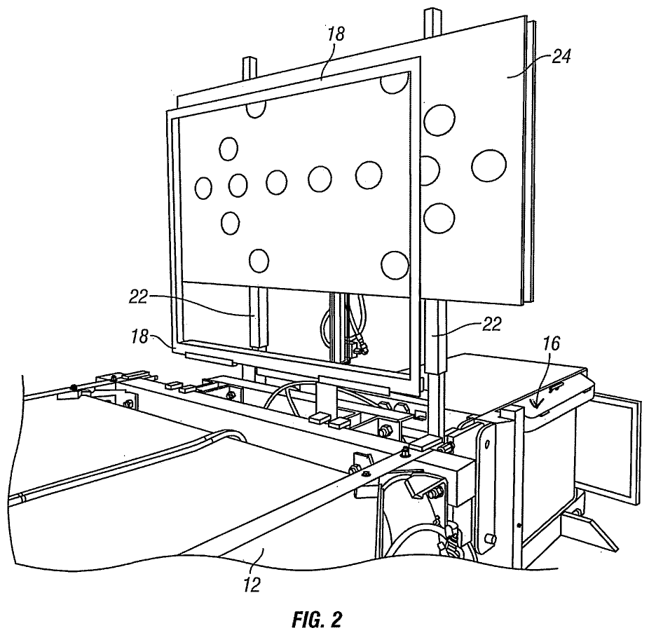

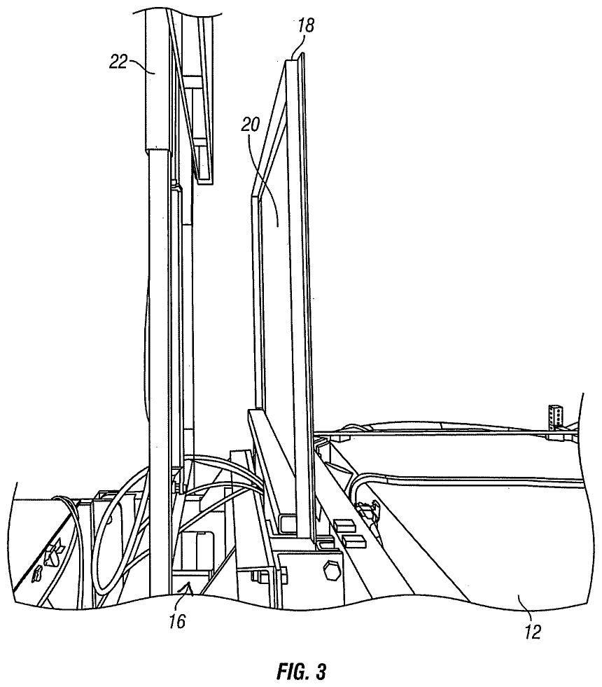

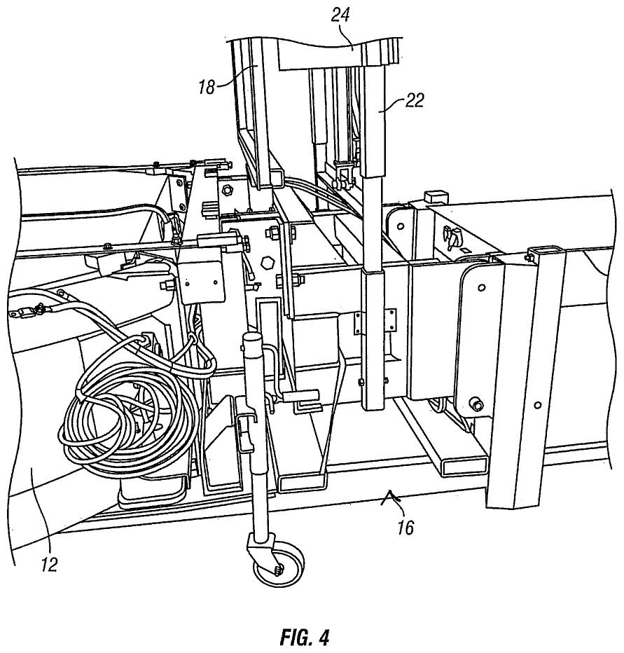

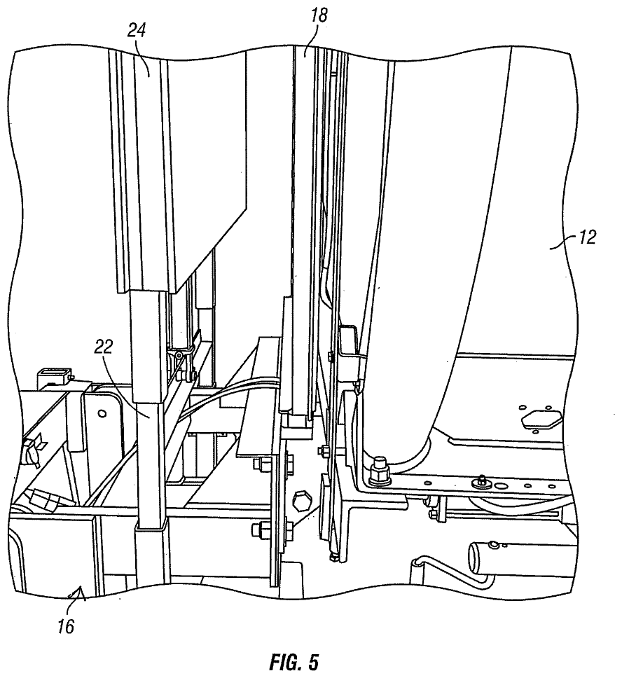

The inventive sign display system comprises a sign holder frame 18 extending upwardly from the backup frame 16, which is adapted to support and display a first informational sign 20 (FIG. 1). In the illustrated embodiment, the sign holder frame 18 is positionally fixed in a vertical orientation, as shown, and the first informational sign 20 is a sign displaying written information to an approaching motorist, such as “Work Zone Ahead” or “Right Lane Closed Ahead”. Forwardly of the sign holder frame 18 upwardly extending support posts 22 are disposed on the backup frame for supporting a second informational sign 24 (FIG. 2). The second informational sign 24 may, in illustrated embodiments, comprise an arrowboard displaying a flashing arrow to advise approaching motorists to move to the right or left. To an approaching motorist, the second informational sign 24 disposed on the upwardly extending support posts 22 is behind the first informational sign 20. The support posts 22 are upwardly extendable, and downwardly deployable, by means of a hydraulic powered vertical lift, which may be sequenced to raise and lower the support posts 22, which are of a telescoping construction, to consequently raise the second informational sign 24 to a display position, above the first informational sign 20, and to lower the second informational sign to a stowed position behind the first informational sign 20. The second informational sign 24 is shown in its raised display position in FIGS. 1 and 3, and in its lowered stowed position in FIGS. 2, 4, and 5. In the illustrated and described embodiment, the vertical lift is powered by the same on-board hydraulic system that rotates the TMA into both the travel/storage orientation shown in FIG. 5 and the deployed orientation shown in the remaining FIGS. 1-4. Of course, while two upwardly extending support posts 22 are illustrated, any number of one or more such support posts may be used to support the second informational sign, depending upon design application considerations.

Although the illustrated embodiment shows the sign holder frame and the upwardly extending support posts being disposed on the backup frame 16, it is within the scope of the invention that these members be disposed on a forward portion of a frame supporting the energy absorbing portions, rather than on the backup frame, if desired.

Accordingly, although an exemplary embodiment of the invention has been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A crash impact attenuator for deployment on a vehicle deployed in a construction zone, comprising:
an energy-absorbing portion, including a frame for supporting the energy-absorbing portion;
a backup frame adapted to join the crash impact attenuator to a vehicle;
a sign holder frame extending upwardly from the backup frame, the sign holder frame being adapted to support a first informational sign; and
at least one upwardly extending support post extending from one of the backup frame and the energy-absorbing portion frame, for supporting a second informational sign forwardly of the sign holder frame, so that the second informational sign is behind the sign holder frame from an approaching motorist's point of view.

2. The crash impact attenuator as recited in claim 1, wherein the at least one upwardly extending support post may be raised to a display position, with the second informational sign thus being positioned above the sign holder frame, and may further be lowered to a stowed position, so that the second informational sign is positioned behind the sign holder frame.

3. The crash impact attenuator as recited in claim 2, wherein the second informational sign comprises an arrowboard.

4. The crash impact attenuator as recited in claim 2, wherein the at least one upwardly extending support post is of a telescoping construction.

5. The crash impact attenuator as recited in claim 4, and further comprising a hydraulic powered vertical lift which is arranged to raise and lower the at least one upwardly extending support post.

6. The crash impact attenuator as recited in claim 1, wherein the at least one upwardly extending support post comprises two upwardly extending support posts.

7. The crash impact attenuator as recited in claim 5, wherein the crash impact attenuator comprises an on-board hydraulic system for rotating the crash impact attenuator into both travel/storage and deployed orientations, and the hydraulic powered vertical lift is powered by the on-board hydraulic system.

8. The crash impact attenuator as recited in claim 1, wherein the at least one upwardly extending support post extends from the backup frame.

9. A method of displaying informational messages to passing motorists from a construction vehicle equipped with a rear-mounted crash attenuator, the method comprising:
providing a first informational sign disposed in a sign holder frame extending upwardly forwardly of the crash attenuator; and
providing a second informational sign disposed on at least one upwardly extending support post, wherein the second informational sign is displayed above the first informational sign.

10. The method as recited in claim 9, and further comprising a step of raising the at least one upwardly extending support post to dispose the second informational sign in a display position above the first informational sign.

11. The method as recited in claim 9, and further comprising a step of lowering the at least one support post to dispose the second informational sign in a stowed position behind the first informational sign.

12. The method as recited in claim 9, wherein the second informational sign comprises an arrowboard.
